(19) United States
(12) Patent Application Publication
(10) Pub. No.: US 2024/0228711 A9
(43) Pub. Date: Jul. 11, 2024

(54) NON-BREATHABLE FILMS INCLUDING POLYMER BLENDS AND METHODS FOR MAKING THE SAME

(71) Applicant: DOW GLOBAL TECHNOLOGIES LLC, Midland, MI (US)

(72) Inventors: Maria Dolores Sanchez, Murcia (ES); Eduardo Alvarez-Acedo, Tarragona (ES); Barbara Bonavoglia, Horgen (CH); Jozef Van Dun, Antwerp (BE)

(21) Appl. No.: 18/276,974

(22) PCT Filed: Feb. 18, 2022
(86) PCT No.: PCT/US22/16972

§ 371 Date: Aug. 11, 2023

Related U.S. Application Data
(60) Provisional application No. 63/153,710, filed on Feb. 25, 2021.

(51) Int. Cl. C08J 5/18; C08K 3/26; C08L 23/06

(52) U.S. Cl. CPC C08J 5/18; C08K 3/26; C08L 23/06; C08J 2323/06; C08K 2003/265; C08L 2205/025; C08L 2207/066

(57) ABSTRACT

Provided are non-breathable films including specific polymer blends, and methods for making such films. The films comprise an anhydride and/or carboxylic acid functionalized ethylene/alpha-olefin interpolymer, a linear low density polyethylene, and an inorganic filler. The method of manufacturing the film comprises extruding an anhydride and/or carboxylic acid functionalized ethylene/alpha-olefin interpolymer, a linear low density polyethylene, and an inorganic filler to form the film and stretching the film. The films according to embodiments disclosed herein can exhibit low WVTR values and improved modulus while also incorporating significant amounts of inorganic filler at low gauges.

### TECHNICAL FIELD

Embodiments of the present disclosure generally relate to films, and more particularly relate to non-breathable films including specific polymer blends.

### INTRODUCTION

Non-breathable films are used in a wide variety of applications, including baby diapers, adult incontinence products, surgical gowns, and other hygiene and medical applications. For example, diaper backsheet films may be classified as breathable or non-breathable films depending on the microporous morphology or water vapor transmission rate (“WVTR”) of the films. Breathable films are typically made by incorporating high amounts (greater than 30 wt. %) of inorganic filler (e.g., CaCO₃) into polymers to create pores, deliver breathability, and reduce costs. Although non-breathable films may include fillers, such as CaCO₃, to reduce costs, they do not include high amounts (greater than 30 wt. %) of filler as fillers such as CaCO₃ can create pores, deliver breathability, and compromise mechanical properties. Non-breathable films instead are typically formed from blends of high density polyethylene (HDPE), linear low density polyethylene (LLDPE), and low density polyethylene (LDPE), where, in summary, HDPE provides stiffness, LLDPE provides toughness, and LDPE provides process ability.

Accordingly, there remains a need for cost-effective, non-breathable film formulations that include inorganic fillers and exhibit improved or maintained mechanical properties, such as modulus and tensile properties.

### SUMMARY

Embodiments of the present disclosure meet the foregoing needs by providing films that can include higher amounts (from 40 to 70 wt. %) of inorganic filler and low WVTR (less than 1,100 g/m²*day). The films of the present invention include an anhydride and/or carboxylic acid functionalized ethylene/alpha-olefin interpolymer and a linear low density polyethylene. Without being bound by any theory, the anhydride and/or carboxylic acid functionalized ethylene/alpha-olefin interpolymer in combination with the linear low density polyethylene and inorganic filler prevents cavitation and so decreases or removes breathability while maintaining or improving mechanical properties. The films according to embodiments disclosed herein can exhibit low WVTR values and improved modulus while also incorporating significant amounts of inorganic filler at low gauges.

Disclosed herein is a film. The film comprises (a) from 1 to 15 wt. % of an anhydride and/or carboxylic acid functionalized ethylene/alpha-olefin interpolymer having a melting point of less than 100° C.; (b) from 20 to 59 wt. % of a linear low density polyethylene having a density of from 0.900 g/cm³ to 0.940 g/cm³ and a melt index (I₂) of from 0.1 g/10 min to 10.0 g/10 min; and (c) from 40 to 70 wt. % of an inorganic filler selected from the group consisting of sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, and a combination thereof; and wherein wt. % is based on total weight of the film; and wherein the film has a water vapor transmission rate (WVTR) of less than 1,100 g/m²*day and a stretch ratio of at least 2:1.

Also disclosed herein is a method for manufacturing a film. The method comprises providing from 1 to 15 wt. % of an anhydride and/or carboxylic acid functionalized ethylene/alpha-olefin interpolymer having a melting point of less than 100° C.; from 20 to 59 wt. % of a linear low density polyethylene having a density of from 0.900 g/cm³ to 0.940 g/cm³ and a melt index (I₂) of from 0.1 g/10 min to 10.0 g/10 min; and from 40 to 70 wt. % of an inorganic filler, the inorganic filler selected from the group consisting of sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, and a combination thereof; wherein wt. % is based on total weight of the film; extruding the anhydride and/or carboxylic acid functionalized ethylene/alpha-olefin interpolymer, linear low density polyethylene, and inorganic filler to form the film; and stretching the film to a stretch ratio of at least 2:1.

These and other embodiments are described in more detail in the Detailed Description.

### DETAILED DESCRIPTION

Aspects of the disclosed films are described in more detail below. The films can have a wide variety of applications, including, for example, baby diapers, adult incontinence products, surgical gowns, and other hygiene and medical applications. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

As used herein, the term “polymer” means a polymeric compound prepared by polymerizing monomers, whether of the same or a different type. The generic term polymer thus embraces the term homopolymer (employed to refer to polymers prepared from only one type of monomer), and the term copolymer or interpolymer. Trace amounts of impurities (for example, catalyst residues) may be incorporated into and/or within the polymer. A polymer may be a single polymer, a polymer blend, or a polymer mixture, including mixtures of polymers that are formed in situ during polymerization.

As used herein, the term “polyethylene” means a polymer comprising a majority amount (>50 mol %) of units which have been derived from ethylene monomer.

As used herein, the term “interpolymer” refers to polymers prepared by the polymerizations of at least two different types of monomers.

As used herein, the term “ethylene/alpha-olefin interpolymer” refers to an interpolymer that comprises, in polymerized form, a majority amount of ethylene monomer (based on the weight of the interpolymer), and at least one alpha-olefin monomer.

As used herein, the term “anhydride and/or carboxylic acid functionalized ethylene/alpha-olefin interpolymer” refers to an ethylene/alpha-olefin interpolymer that comprises at least one anhydride group and/or at least one acid group (for example, —COOH formed by the hydrolysis of an anhydride) linked by a covalent bond. An example of an anhydride and/or carboxylic acid functionalized ethylene/alpha-olefin interpolymer is a maleic anhydride functionalized ethylene/alpha-olefin interpolymer.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The film disclosed herein comprises an anhydride and/or carboxylic acid functionalized ethylene/alpha-olefin interpolymer, a linear low density polyethylene, and an inorganic filler.

In embodiments, the film comprises from 1 to 15 weight percent (“wt. %”) of an anhydride and/or carboxylic acid functionalized ethylene/alpha-olefin interpolymer, where wt. % is based on total weight of the film. All individual values and subranges of from 1 to 15 wt. % are disclosed and included herein. For example, the film can comprise from 1 to 15 wt. %, from 5 to 15 wt. %, or from 8 to 12 wt. % of an anhydride and/or carboxylic acid functionalized ethylene/alpha-olefin interpolymer, where wt. % is based on total weight of the film.

In embodiments, the anhydride and/or carboxylic acid functionalized ethylene/alpha-olefin interpolymer has a melting point of less than 100° C., where melting point can be measured in accordance with ISO 3146. All individual values and subranges of less than 100° C. are disclosed and included herein. For example, the anhydride and/or carboxylic acid functionalized ethylene/alpha-olefin interpolymer can have a melting point of less than 100° C., less than 95° C., less than 90° C., less than 85° C., less than 80° C., less than 75° C., less than 70° C., or less than 65° C.; or can have a melting point in the range of from 55° C. to 95° C., from 55° C. to 85° C., from 55° C. to 75° C., from 55° C. to 65° C., from 60° C. to 90° C., from 60° C. to 80° C., or from 60° C. to 70° C., where melting point can be measured in accordance with ISO 3146.

In embodiments, the anhydride and/or carboxylic acid functionalized ethylene/alpha-olefin interpolymer has a density of less than 0.910 grams per cubic centimeter (g/cm³ or g/cc). All individual values and subranges of less than 0.910 g/cc are disclosed and included herein. For example, the anhydride and/or carboxylic acid functionalized ethylene/alpha-olefin interpolymer can have a density of less than 0.910 g/cc, less than 0.900 g/cc, less than 0.890 g/cc, less than 0.880 g/cc, or less than 0.870 g/cc; or can have a density in the range of from 0.860 to 0.910 g/cc, from 0.860 to 0.900 g/cc, from 0.860 to 0.890 g/cc, from 0.860 to 0.880 g/cc, or from 0.865 to 0.875 g/cc.

In embodiments, the anhydride and/or carboxylic acid functionalized ethylene/alpha-olefin interpolymer has an anhydride or acid content of from 0.1 to 2.0 wt. %, where wt. % of the anhydride or acid content is based on total weight of the anhydride and/or carboxylic acid functionalized ethylene/alpha-olefin interpolymer. All individual values and subranges of from 0.1 to 2.0 wt. % are disclosed and included herein. For example, the anhydride and/or carboxylic acid functionalized ethylene/alpha-olefin interpolymer can have an anhydride or acid content of from 0.1 to 2.0 wt. %, from 0.3 to 2.0 wt. %, from 0.5 to 2.0 wt. %, from 0.7 to 2.0 wt. %, or from 1.0 to 2.0 wt. %, where wt. % of the anhydride or acid content is based on total weight of the anhydride and/or carboxylic acid functionalized ethylene/alpha-olefin interpolymer.

In embodiments, the anhydride and/or carboxylic acid functionality is grafted to the ethylene/alpha-olefin interpolymer.

In embodiments, the anhydride and/or carboxylic acid functionalized ethylene/alpha-olefin interpolymer is a maleic anhydride functionalized ethylene/alpha-olefin interpolymer. For example, in embodiments, the film comprises from 1 to 15 wt. %, of a maleic anhydride functionalized ethylene/alpha-olefin interpolymer having a melting point of less than 100° C., where wt. % is based on total weight of the film.

Examples of anhydride and/or carboxylic acid functionalized ethylene/alpha-olefin interpolymers suitable for use in embodiments of the present invention include certain anhydride and/or carboxylic acid functionalized ethylene/alpha-olefin interpolymers under the trade name BYNEL™, including, for example, BYNEL™ 46E1060, commercially available from The Dow Chemical Company (Midland, MI).

The film disclosed herein comprises a linear low density polyethylene. In embodiments the film comprises from 20 to 59 wt. % of a linear low density polyethylene, where wt. % is based on total weight of the film. All individual values and subranges of from 20 to 59 wt. % are disclosed and incorporated herein. For example, the film can comprise from 20 to 59 wt. %, from 20 to 50 wt. %, from 20 to 45 wt. %, from 30 to 59 wt. %, from 30 to 50 wt. %, from 30 to 45 wt. %, from 35 to 59 wt. %, from 35 to 50 wt. %, or from 35 to 45 wt. % of a linear low density polyethylene, where wt. % is based on total weight of the film.

In embodiments the linear low density polyethylene has a density of from 0.900 g/cm³ to 0.940 g/cm³. All individual values and subranges of from 0.900 g/cm³ to 0.940 g/cm³ are disclosed and incorporated herein. For example, the linear low density polyethylene can have a density of from 0.900 g/cm³ to 0.940 g/cm³, from 0.905 g/cm³ to 0.935 g/cm³, from 0.910 g/cm³ to 0.930 g/cm³, or from 0.915 g/cm³ to 0.925 g/cm³, where density can be measured in accordance with ASTM D792.

In embodiments, the linear low density polyethylene has a melt index (I 2) of from 0.1 g/10 min to 10.0 g/10 min. All individual values and subranges of from 0.1 g/10 min to 10.0 g./10 min are disclosed and incorporated herein. For example, the linear low density polyethylene can have a melt index (I 2) of from 0.1 g/10 min to 10.0 g/10 min, from 0.5 g/10 min to 10.0 g/10 min, from 1.0 g/10 min to 10.0 g/10 min, from 0.1 g/10 min to 5.0 g/10 min, from 0.5 g/10 min to 5.0 g/10 min, or from 1.0 g/10 min to 5.0 g/10 min, where melt index (I 2) can be measured in accordance with ASTM D1238.

Examples of linear low density polyethylenes suitable for use in embodiments of the present invention include certain linear low density polyethylenes under the trade name DOWLEX™, including, for example, DOWLEX™ 2111GC Polyethylene Resin, commercially available from The Dow Chemical Company (Midland, MI).

The film disclosed herein also comprises an inorganic filler. The inorganic filler is selected from the group consisting of sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, and a combination thereof. In embodiments, the film comprises from 40 to 70 wt. % of an organic filler selected from the group consisting of sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, and a combination thereof. All individual values and subranges of from 40 to 70 wt. % are disclosed and incorporated herein. For example, the film can comprise from 40 to 70 wt. %, from 40 to 60 wt. %, from 40 to 55 wt. %, from 45 to 70 wt. %, from 45 to 60 wt. %, or from 45 to 55 wt. %, of an inorganic filler, wherein wt. % is based on total weight of the film.

In embodiments, the inorganic filler has a median particle size (D50) of less than 5 microns (also referred to as micrometers (μm)). All individual values and subranges of less than 5 microns are disclosed and included herein. For example, the inorganic filler can have a median particle size (D50) of less than 4 microns, less than 3 microns, less than 2 microns, or less than 1 microns, or can be in the range of from 0.1 to 4 microns, from 0.1 to 3 microns, from 0.1 to 2 microns, or from 0.1 to 1 microns.

In embodiments, the inorganic filler of the film is calcium carbonate.

The film disclosed herein may incorporate additives, such as, antioxidants (e.g., hindered phenolics, such as, IRGANOX® 1010 or IRGANOX® 1076, supplied by BASF), phosphites (e.g., IRGAFOS® 168, also supplied by BASF), processing aids, uv light stabilizers, thermal stabilizers, pigments, colorants, anti-stat additives, flame retardants, slip agents, antiblock additives, biocides, antimicrobial agents, and clarifiers/nucleators (e.g., HYPERFORM™ HPN-20E, MILLAD™ 3988, MILLAD™ NX 8000, available from Milliken Chemical). Additives can be included in the film at levels typically used in the art to achieve their desired purpose. In some examples, the one or more additives are included in amounts ranging from 0 to 10 wt. %, based on total weight of the film, from 0 to 5 wt. %, based on total weight of the film, from 0.001 to 5 wt. %, based on total weight of the film, from 0.001 to 3 wt. %, based on total weight of the film, from 0.05 to 3 wt. %, based on total weight of the film, or from 0.05 to 2 wt. %, based on total weight of the film.

The film disclosed herein is a non-breathable film. As used herein, the term “non-breathable” refers to a film having a water vapor transmission rate (WVTR) of less than 1,100 g/m²*day. The film of the present invention can permit higher amounts of inorganic filler (from 40 to 70 wt. % of inorganic filler) while maintaining lower WVTR values (less than 1,100 g/m²*day). This result is unexpected because higher levels of filler typically result in greater cavitation and higher WVTR values in films. Without being bound by any theory, the anhydride and/or carboxylic acid functionalized ethylene/alpha-olefin interpolymer in combination with the linear low density polyethylene and inorganic filler prevents cavitation and so decreases WVTR while maintaining or improving mechanical properties. It is believed that the anhydride and/or carboxylic acid functionalized ethylene/alpha-olefin interpolymer can interact with the inorganic filler and linear low density polyethylene to prevent cavitation and decrease pore formation and WVTR.

The film disclosed herein has a water vapor transmission rate (WVTR) of less than 1,100 g/m²*day. All individual values and subranges of less than 1,100 g/m²*day are disclosed and incorporated herein. For example, the film can have a WVTR less than 1,100 g/m²*day, less than 1,000 g/m²*day, less than 900 g/m²*day, less than 800 g/m²*day, less than 700 g/m²*day, less than 600 g/m²*day, or less than 500 g/m²*day; or the film can have a WVTR in the range of from 400 to 1,100 g/m²*day, from 400 to 1,000 g/m²*day, from 400 to 800 g/m²*day, from 400 to 600 g/m²*day, from 500 to 1,100 g/m²*day, or from 500 to 800 g/m²*day, where WVTR can be measured in accordance with ASTM E398.

The basis weight of the film is not particularly limited, but in some embodiments, may be from 5 to 50 gsm. The basis weight of the film can depend on a number of factors including the desired properties of the film, the end use application of the film, the equipment available to manufacture the film, the cost allowed by the application, and other factors. All individual values and subranges of from 5 to 50 gsm are included and disclosed herein. For example, in some embodiments, the film has a basis weight of from 5 to 50 gsm, 5 to 40 gsm, 5 to 30 gsm, 5 to 20 gsm, 10 to 50 gsm, 10 to 40 gsm, 10 to 30 gsm, or 10 to 20 gsm.

The film disclosed herein has a stretch ratio of at least 2:1. Although stretching the film can increase WVTR, stretching can increase or improve mechanical properties such as modulus and tensile properties of the film, and can permit downgauging of the film. The film of the present invention according to embodiments disclosed herein permits higher levels of inorganic filler while keeping WVTR at low levels (less than 1,100 g/m²*day) and while maintaining or improving mechanical properties such as modulus or tensile properties. In embodiments, the film has a stretch ratio of at least 2:1, at least 3:1, at least 4:1, or at least 5:1, or has a stretch ratio in the range of 2:1 to 6:1, or alternatively 3:1 to 6:1.

In addition to having a WVTR of less than 1,100 g/m²*day and a stretch ratio of at least 2:1, the film according to embodiments disclosed herein can have a force at 5% strain in the machine direction of greater than 2.000 N/15 mm width of the film (or alternatively greater than 2.500 N/15 mm width of the film, or greater than 3.000 N/15 mm width of the film, or greater than 3.500 N/15 mm width of the film, or greater than 4.000 N/15 mm width of the film), where force at 5% strain in the machine direction can be measured in accordance with the test method described below.

The film according to embodiments disclosed herein can be defined in terms of its force at 5% strain in the machine direction (MD), stretch ratio, wt. % of inorganic filler, and WVTR. For example, the following equation can be used to characterize the film:

$${X}_{NBB} = \frac{Force at 5 \% Strain M D \cdot Stretch ratio \cdot wt . \% of Inorganic Filler}{WVTR}$$

In embodiments, the film has an X_{NBB}, where X_{NBB} is defined as noted in the above equation, of greater than or equal to 0.0060, or alternatively greater than or equal to 0.0080, or alternatively greater than or equal to 0.0100.

It is also contemplated that a film according to embodiments disclosed herein may comprise additional layers, either coextruded, or as a laminate. These layers may be selected to provide additional functionality, for example, layers to provide extra strength, adhesion to another substrate such as a non-woven, and/or aesthetic properties such as feel or appearance.

Some embodiments of the present invention relate to laminates comprising one or more films of the present invention. For example, films of the present invention can be used in film/non-woven laminates. Typical non-wovens for use in such laminates can be spunlaid, airlaid, carded webs, or composities thereof. Typical non-woven composites for use in laminates with a film of the present invention include three beams of spunbond, (e.g., S/S/S), a spunbond/meltblown/spunbond composite (e.g., S/M/S), and others. Common methods for joining the film to the non-wovens include, for example, bonded hot melt adhesive lamination, ultra-sonic bonding, and thermal bonding through a calendar or nip roll. In embodiments, a laminate comprising the film of the present invention is in adhering contact with a nonwoven or a second film.

The present invention also relates to articles comprising at least one of the inventive films disclosed herein. Articles which comprise the inventive film can be used in disposable hygiene and medical products as liquid impermeable layers. Examples of articles comprising such films include diapers, training pants, feminine hygiene products, adult incontinence products, medical drapes, medical gowns, surgical suits, and others. Films can be incorporated into such articles using techniques known to those of skill in the art based on the teachings herein.

The film described herein may be made via a number of processes. Exemplary processes may include making the film into a blown or cast film, and the films may be fabricated via the blown, cast or extrusion coating processes. A film can be stretched via machine direction stretching, cross-direction stretching, ring rolling stretching, cold drawing, or a combination thereof.

A method of manufacturing the film of the present invention is also disclosed herein. In embodiments, a method for manufacturing a film comprises providing from 1 to 15 wt. % of an anhydride and/or carboxylic acid functionalized ethylene/alpha-olefin interpolymer having a melting point of less than 100° C.; from 20 to 59 wt. % of a linear low density polyethylene having a density of from 0.900 g/cm³ to 0.940 g/cm³ and a melt index (I 2) of from 0.1 g/10 min to 10.0 g/10 min; and from 40 to 70 wt. % of an inorganic filler, the inorganic filler selected from the group consisting of sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, and a combination thereof; wherein wt. % is based on total weight of the film; extruding the anhydride and/or carboxylic acid functionalized ethylene/alpha-olefin interpolymer, linear low density polyethylene, and inorganic filler to form the film; and stretching the film to a stretch ratio of at least 2:1.

In embodiments, the method of manufacturing a film comprises the step of compounding the anhydride and/or carboxylic acid functionalized ethylene/alpha-olefin interpolymer, the linear low density polyethylene, and the inorganic filler prior to extruding the material into a film. For example, in embodiments, a method for manufacturing a film comprises providing from 1 to 15 wt. % of an anhydride and/or carboxylic acid functionalized ethylene/alpha-olefin interpolymer having a melting point of less than 100° C.; from 20 to 59 wt. % of a linear low density polyethylene having a density of from 0.900 g/cm³ to 0.940 g/cm³ and a melt index (I 2) of from 0.1 g/10 min to 10.0 g/10 min; and from 40 to 70 wt. % of an inorganic filler, the inorganic filler selected from the group consisting of sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, and a combination thereof; wherein wt. % is based on total weight of the film; compounding the anhydride and/or carboxylic acid functionalized ethylene/alpha-olefin interpolymer, linear low density polyethylene, and inorganic filler to form a masterbatch formulation; extruding the masterbatch formulation to form a film; and stretching the film to a stretch ratio of at least 2:1.

### Test Methods

### Density

Density is measured in accordance with ASTM D792, and expressed in grams/cm³ (g/cc or g/cm³).

### Melt Index (I₂)

Melt index (I 2) is measured in accordance with ASTM D-1238 at 190° C. at 2.16 kg. The values are reported in g/10 min, which corresponds to grams eluted per 10 minutes.

### Melting Point

Melting point is measured in accordance with ISO 3146.

### Water Vapor Transmission Rate (WVTR)

Water Vapor Transmission Rate (WVTR) is measured in accordance with ASTM E398.

### Force at 5% Strain in MD or Tensile Absolute

Force at 5% strain in the Machine Direction (also referred to as Tensile Absolute) is measure in accordance with ISO 527-3. The stress at 5% elongation value is reported. The width of the sample is 15 mm and its length is 100 mm, and the values reported are N/15 mm width of the film.

### Examples

The following examples illustrate features of the present disclosure but are not intended to limit the scope of the disclosure.

### Materials Used

The following materials are included in the example films discussed below.

DOWLEX™ 2107GC, an ethylene-octene copolymer having a density of 0.917 g/cm³ and melt index (I₂) of 2.3 g/10 min—commercially available from The Dow Chemical Company (Midland, MI).

DOWLEX™ 2111GC, a linear low density polyethylene having a density of 0.920 g/cm³ and melt index (I₂) of 3.7 g/10 min—commercially available from The Dow Chemical Company (Midland, MI).

BYNEL™ 46E1060, a maleic anhydride functionalized ethylene/alpha-olefin interpolymer having a melting point of 62.8° C., a density of 0.87 g/cm³, a melt index (I₂) of 3 g/10 min, and maleic anhydride content between 1.0 and 2.0 wt. %— commercially available from The Dow Chemical Company (Midland, MI).

ELVALOY™ AC 1820, an ethylene/methyl acrylate copolymer having a melting point of 92° C., a density of 0.942 g/cm³, a melt index (I 2) of 8 g/10 min, and acrylate content of 20 wt. %— commercially available from The Dow Chemical Company (Midland, MI).

INFUSE™ 9507, an olefin block copolymer having a density of 0.866 g/cm³ and melt index (I 2) of 5.0 g/10 min—commercially available from The Dow Chemical Company (Midland, MI).

OmyaFilm 753, a calcium carbonate (CaCO₃) commercially available from Omya AG.

Films having a final basis weight of 15 gsm are formed in accordance with the formulations and procedures below. Formulations of the films are in accordance with the description in Table 1 below and are designated Comparative Examples 1-5 and Inventive Example 1.

TABLE 1
Formulations

| Example | Formulation |
|---|---|
| Comparative Example 1 | 100 wt. % DOWLEX ™ 2107GC |
| Comparative Example 2 | 50 wt. % DOWLEX ™ 2111GC + |
| | 50 wt. % OmyaFilm 753 |
| Comparative Example 3 | 40 wt. % DOWLEX ™ 2111GC + |
| | 10 wt. % ELVALOY ™ AC 1820 + |
| | 50 wt. % OmyaFilm 753 |
| Comparative Example 4 | 40 wt. % DOWLEX ™ 2111GC + |
| | 10 wt. % INFUSE ™ 9507 + |
| | 50 wt. % OmyaFilm 753 |
| Inventive Example 1 | 40 wt. % DOWLEX ™ 2111GC + |
| | 10 wt. % BYNEL ™ 46E1060 + |
| | 50 wt. % OmyaFilm 753 |

To form films, the materials for each of Comparative Examples 2-5 and Inventive Example 1 are extruded on a Buss Kneader compounding line into a masterbatch formulation. Comparative Example 1 is not formed into a masterbatch formulation as it is a single polymer formulation. The formulations are then processed on a Collin Cast extrusion line into monolayer films. The films have a final film basis weight of 15 gsm. Table 2 below provides the film processing parameters.

TABLE 2
Film Processing Parameters

| | |
|---|---|
| Amps - Ext. C (A) | 2.4 |
| Die gap (mm) | 0.8 |
| Layer Percentage - Ext A (%) | 0 |
| Layer Percentage - Ext C (%) | 100 |
| Layer Percentage - Ext E (%) | 0 |
| Melt Pressure - Ext. C (bar) | 96 |
| Melt Temperature - Ext. C (° C.) | 231 |
| RPM - Ext. C (rpm) | 29 |
| Structure | C |
| Take-off Speed (m/min) | 7.7 |
| Total Output (kg/h) | 3.8 |

Sets of films are produced from each example formulation with different stretch ratios. Comparative Examples 1A, 2A, and Inventive Example 1A are films that have a stretch ratio of “0” (i.e., are not stretched at all). Comparative Examples 2B, 3B, 4B, and Inventive Example 1B are stretched in the machine direction to a minimum stretch ratio (MSR), which is intrinsic to each film. As known to those skilled in the art, films have a MSR where the film is completely stretched throughout its full width and void of tiger stripes. The MSR for Comparative Example 2B is 3.7:1; the MSR for Comparative Example 3B is 3.9:1; the MSR for Comparative Example 4B is 3.7:1; and the MSR for Inventive Example 1B is 4.2:1. Comparative Examples 2C, 3C, 4C, and Inventive Example 1C are stretched in the machine direction to a stretch ratio of 5.5:1.

Stretching in the machine direction is performed in accordance with the machine direction orientation processing parameters in Table 3 below.

TABLE 3
Machine Direction Orientation Processing Parameters

| Pre-heating group | Stretching Group I | Annealing | Cooling |
|---|---|---|---|
| (° C.) | (° C.) | (° C.) | (° C.) |
| 50 | 65 | 50 | 30 |

The WVTR of each of the Example films is measured. Table 4 below provides the results.

TABLE 4
WVTR Results

| Example | Stretch Ratio | WVTR (g/m²*day) |
|---|---|---|
| Comparative Example 1A | 0 | 36 |
| Comparative Example 2A | 0 | 36 |
| Comparative Example 2B | 3.7 (MSR) | 3392 |
| Comparative Example 2C | 5.5 | 3853 |
| Comparative Example 3B | 3.9 (MSR) | 3852 |
| Comparative Example 3C | 5.5 | 4136 |
| Comparative Example 4B | 3.7 (MSR) | 3763 |
| Comparative Example 4C | 5.5 | 3671 |
| Inventive Example 1A | 0 | 35 |
| Inventive Example 1B | 4.2 (MSR) | 523 |
| Inventive Example 1C | 5.5 | 1045 |

Inventive Examples 1B and 1C show the surprisingly and unexpected results where the WVTR values are lower in comparison to the corresponding comparative examples that have been stretched at the same or similar stretch ratios and have the same amount of calcium carbonate. Without being bound by any theory, the maleic anhydride functionalized ethylene/alpha-olefin interpolymer of Inventive Example 1 can interact with the filler and polymer matrix to decrease pore formation, WVTR, and breathability.

The force at 5% strain in the MD is also measured. Table 5 below provides the results.

TABLE 5
Force at 5% Strain MD Data

| | Stretch | Force at 5% Strain in MD |
|---|---|---|
| Example | Ratio | (N/15 mm) |
| Comparative Example 1A | 0 | 0.927 |
| Comparative Example 2A | 0 | 0.755 |
| Comparative Example 2B | 3.7 (MSR) | 2.06 |
| Comparative Example 2C | 5.5 | 4.23 |
| Comparative Example 3B | 3.9 (MSR) | 1.880 |
| Comparative Example 3C | 5.5 | 2.904 |
| Comparative Example 4B | 3.7 (MSR) | 1.383 |
| Comparative Example 4C | 5.5 | 2.147 |
| Comparative Example 5B | 3.6 (MSR) | 1.549 |
| Comparative Example 5C | 5.5 | 2.205 |
| Inventive Example 1A | 0 | 0.678 |
| Inventive Example 1B | 4.2 (MSR) | 2.691 |
| Inventive Example 1C | 5.5 | 4.283 |

As shown in Table 5, Inventive Examples 1B and 1C have relatively higher values for Force at 5% Strain in the MD in comparison to the Comparative Example with the same or similar stretch ratio and same amount of calcium carbonate. The Inventive Examples therefore show lower WVTR and improved modulus or Force at 5% strain in the MD in comparison to the corresponding Comparative Examples. The improved Force at 5% strain in the MD can result in an increase in hydrostatic pressure resistance which is important, for example, during packaging processes and for resisting pressure of liquid that can be captured in an article such as a diaper when a person sits on it. The Inventive Films exhibit low WVTR values and improved modulus while also incorporating significant amounts of inorganic filler at low gauges.

A parameter, X_{NBB}, can be used to show the advantageous results of the present invention and Inventive Example 1. X_{NBB} corresponds with the following formula:

$${X}_{N B B} = \frac{Force at 5 \% Strain M D \cdot Stretch ratio \cdot \% wt . Filler}{W V T R}$$

The X_{NBB} for the Comparative and Inventive Examples is calculated and provided in Table 6 below.

TABLE 6
X_{NBB} Results

| Example | Stretch Ratio | X_{NBB} |
|---|---|---|
| Comparative Example 1A | 0 | 0 |
| Comparative Example 2A | 0 | 0 |
| Comparative Example 2B | 3.7 (MSR) | 0.0011 |
| Comparative Example 2C | 5.5 | 0.0030 |
| Comparative Example 3B | 3.9 (MSR) | 0.0010 |
| Comparative Example 3C | 5.5 | 0.0019 |
| Comparative Example 4B | 3.7 (MSR) | 0.0007 |
| Comparative Example 4C | 5.5 | 0.0016 |
| Inventive Example 1A | 0 | 0 |
| Inventive Example 1B | 4.2 (MSR) | 0.0108 |
| Inventive Example 1C | 5.5 | 0.0113 |

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A film comprising:
(a) from 1 to 15 wt. % of an anhydride and/or carboxylic acid functionalized ethylene/alpha-olefin interpolymer having a melting point of less than 100° C.;
(b) from 20 to 59 wt. % of a linear low density polyethylene having a density of from 0.900 g/cm³ to 0.940 g/cm³ and a melt index (I₂) of from 0.1 g/10 min to 10.0 g/10 min; and
(c) from 40 to 70 wt. % of an inorganic filler selected from the group consisting of sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, and a combination thereof; and
wherein wt. % is based on total weight of the film; and
wherein the film has a water vapor transmission rate (WVTR) of less than 1,100 g/m²*day and a stretch ratio of at least 2:1.

2. The film of claim 1, wherein the anhydride and/or carboxylic acid functionalized ethylene/alpha-olefin interpolymer has an anhydride or acid content of from 0.1 to 2.0 wt. %, where wt. % of the anhydride or acid content is based on total weight of the anhydride and/or carboxylic acid functionalized ethylene/alpha-olefin interpolymer.

3. The film of claim 1, wherein the anhydride and/or carboxylic acid functionalized ethylene/alpha-olefin interpolymer is a maleic anhydride functionalized ethylene/alpha-olefin interpolymer.

4. The film of claim 1, wherein the inorganic filler is calcium carbonate.

5. The film of claim 1, wherein the anhydride and/or carboxylic acid functionalized ethylene/alpha-olefin interpolymer has a melting point of less than 65° C.

6. The film of claim 1, wherein the film has a basis weight of from 5 to 50 grams per square meter (gsm).

7. The film of claim 1, wherein the film has a force at 5% strain in the machine direction of greater than 2.000 N/15 mm width of the film.

8. The film of claim 1, where X_{NBB}, defined as
$${X}_{N B B} = \frac{Force at 5 \% Strain M D \cdot Stretch ratio \cdot wt . \% of Inorganic Filler}{W V T R} ,$$
is greater than or equal to 0.0060.

9. A laminate comprising the film of claim 1, in adhering contact with material selected from the group consisting of a nonwoven and a second film.

10. A method for manufacturing a film, the method comprising:
providing from 1 to 15 wt. % of an anhydride and/or carboxylic acid functionalized ethylene/alpha-olefin interpolymer having a melting point of less than 100° C.; from 20 to 59 wt. % of a linear low density polyethylene having a density of from 0.900 g/cm³ to 0.940 g/cm³ and a melt index (I₂) of from 0.1 g/10 min to 10.0 g/10 min; and from 40 to 70 wt. % of an inorganic filler, the inorganic filler selected from the group consisting of sodium carbonate, calcium carbonate, magnesium carbonate, barium sulfate, magnesium sulfate, aluminum sulfate, magnesium oxide, calcium oxide, alumina, mica, talc, silica, clay, glass spheres, titanium dioxide, aluminum hydroxide, zeolites, and a combination thereof; wherein wt. % is based on total weight of the film;
extruding the anhydride and/or carboxylic acid functionalized ethylene/alpha-olefin interpolymer, linear low density polyethylene, and inorganic filler to form the film; and
stretching the film to a stretch ratio of at least 2:1.
